(19) United States
(12) Patent Application Publication
(10) Pub. No.: US 2012/0268778 A1
(43) Pub. Date: Oct. 25, 2012

(54) PRINT RELAY SYSTEM, PRINTING SYSTEM, IMAGE FORMING APPARATUS, METHOD FOR CONTROLLING PRINT RELAY SYSTEM, AND PROGRAM

(75) Inventor: Jun Nakawaki, Yokohama-shi (JP)

(73) Assignee: CANON KABUSHIKI KAISHA, Tokyo (JP)

(21) Appl. No.: 13/388,888

(22) PCT Filed: Nov. 14, 2011
(86) PCT No.: PCT/JP2011/006335

§ 371 Date: Feb. 3, 2012

(30) Foreign Application Priority Data
Nov. 19, 2010 (JP) 2010-259296

(51) Int. Cl. G06K 15/02

(52) U.S. Cl. 358/1.15

(57) ABSTRACT

When it is determined that a desired printing result can be acquired without converting print data of a print server, a print job is generated to acquire the print data not via a relay virtual printer.

### TECHNICAL FIELD

The present invention relates to a print relay system, a printing system, an image forming apparatus, a method for controlling the print relay system, and a program.

### BACKGROUND ART

As a conventional technology, there is a technology for transmitting a printing instruction from a client to a server, and converting contents to be printed into print data by the server that has received the printing instruction.

Japanese Patent Application Laid-Open No. 2008-40991 discusses a system that downloads web content data to be printed by a printer server, and transmits the data to a multifunction peripheral to print it.

As described above, the form where the server provides services to the client has been previously present. Cloud computing, which is a recent focus of attention, is also a form where a server provides services to clients. A main feature of the cloud computing is that data is converted or processed in a dispersive manner by using many computing resources, and requests from many clients are simultaneously processed. Currently, many vendors are appearing to compete with one another to provide a wide variety of services by mounting web services in a cloud computing environment to realize the cloud computing.

Noteworthy among the vendors is Google (registered trademark). The Google (registered trademark), in addition to establishment of many large data centers, provides services in association with devices, and actively pursues development of a data communication mechanism between the devices and the services.

For example, the Google (registered trademark) has developed a data communication mechanism to provide services in association with an image forming apparatus, and released an interface for data communication in a cloud computing environment prepared by the image forming apparatus and the Google (registered trademark). A user who wishes to use this service needs to register information about an image forming apparatus in the cloud computing environment, namely, a service environment for providing services. To register the information about the image forming apparatus, the information about the image forming apparatus is stored in the environment of a service provider, and then registration is completed.

### CITATION LIST

### Patent Literature

PTL 1: Japanese Patent Application Laid-Open No. 2008-40991

### SUMMARY OF INVENTION

### Technical Problem

A print relay system may be disposed between the image forming apparatus and a printing service environment, a protocol defined by printing services in the print relay system may be realized, and an updating frequency of a communication module of the image forming apparatus may be reduced.

When the print relay system is disposed in the above service environment, no consideration is given to an increase of loads or instability of services caused by processing of print data from users from all over the world at the print relay system.

The present invention is directed to a print relay system capable of managing whether to transmit print data via a certain point.

### Solution to Problem

According to an aspect of the present invention, a print relay system capable of communicating with a printing service system that generates and stores print data based on contents instructed to be printed via an information terminal operated by a user and an image forming apparatus that outputs image data based on the print data includes a reception unit configured to receive, when receiving a printing instruction for causing the image forming apparatus to output the image data from the printing service system, the printing instruction without receiving the print data, a determination unit configured to determine whether the print data needs to be received from the printing service system, and a notification unit configured to notify, if the reception unit receives the printing instruction and the determination unit determines that there is no need to receive the print data, of a storage place of the print data stored in the printing service system, to receive and store, if the reception unit receives the printing instruction and the determination unit determines that the print data needs be received, the print data from the printing service system, and to notify of the storage place of the stored print data.

### Advantageous Effects of Invention

According to the present invention, data traffic or loads of the print relay system can be reduced by managing whether to transmit the print data via the print relay system, so that stable services can be realized.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a content printing system.

FIG. 2 illustrates a hardware configuration of each apparatus and each server group included in the content printing system.

FIG. 3 illustrates a software configuration of each apparatus and each server group included in the content printing system.

FIG. 4 illustrates a function realized by a printing control unit.

FIG. 5 illustrates a function realized by a relay virtual printer management service unit.

FIG. 6 illustrates a function realized by a relay virtual printer.

FIG. 7 illustrates a function realized by a printing service.

FIG. 8A illustrates information of a printing service.

FIG. 8B illustrates information stored in a printing service information management unit.

FIG. 8C illustrates information stored in a printer information storage unit.

FIG. 9A illustrates a registration user interface (UI).

FIG. 9B illustrates a print setting screen.

FIG. 9C illustrates a detailed print setting screen.

FIG. 10A illustrates capabilities expressed in an Extensible Markup Language (XML) format.

FIG. 10B illustrates capabilities to be registered in a printing service.

FIG. 10C illustrates print settings expressed in an XML format and transmitted from a printing service.

FIG. 10D illustrates print settings generated again by a relay virtual printer.

FIG. 10E illustrates notification information expressed in an XML format.

FIG. 10F illustrates notification information expressed in an XML format.

FIG. 10G illustrates notification information expressed in an XML format.

FIG. 11A illustrates capabilities expressed in a JavaScript Object Notation (JSON) format.

FIG. 11B illustrates capabilities to be registered in a printing service.

FIG. 11C illustrates print settings expressed in a JSON format and transmitted from a printing service.

FIG. 11D illustrates notification information expressed in a JSON format.

FIG. 11E illustrates notification information expressed in a JSON format.

FIG. 11F illustrates notification information expressed in a JSON format.

FIG. 12 illustrates a state in which a print button is pressed.

FIG. 13 is a sequential diagram illustrating registration of a relay virtual printer in a printing service.

FIG. 14A is a part of a sequential diagram, which is connected to FIG. 14B, illustrating processing for causing an image forming apparatus to perform printing by acquiring print data transmitted from a print server group.

FIG. 14B is a part of a sequential diagram, which is connected to FIG. 14A, illustrating processing for causing an image forming apparatus to perform printing by acquiring print data transmitted from a print server group.

FIG. 15A is a part of a sequential diagram, which is connected to FIG. 15B, illustrating processing for causing an image forming apparatus to perform printing without acquiring print data transmitted from a print server group.

FIG. 15B is a part of a sequential diagram, which is connected to FIG. 15A, illustrating processing for causing an image forming apparatus to perform printing without acquiring print data transmitted from a print server group.

FIG. 16 is a flowchart illustrating determination as to whether to acquire print data from a print server group, which is executed by a print data acquisition unit.

### DESCRIPTION OF EMBODIMENTS

Various exemplary embodiments, features, and aspects of the invention will be described in detail below with reference to the drawings.

A first object of the present invention is to install a print relay system between an environment of a vendor that provides an interface for using web services and an image forming apparatus.

### Example 1

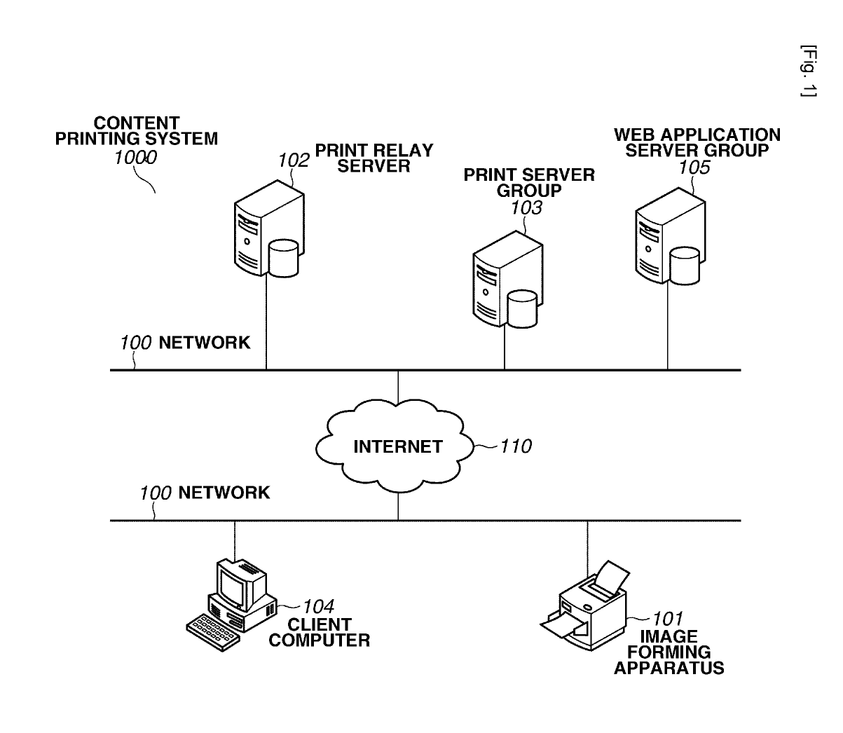

First, a configuration of a content printing system 1000 according to a first exemplary embodiment is described. FIG. 1 illustrates the configuration of the content printing system 1000. The content printing system 1000 includes a client computer 104 and an image forming apparatus 101. The two apparatuses are arranged in a user environment, and interconnected via a network 100. The network 100 is connected to the Internet 110.

The content printing system 1000 includes a web application server group 105 and a print server group 103. The two server groups are provided from the same vendor, and interconnected via a network 100. The network 100 is connected to the Internet 110.

In the first exemplary embodiment, the two server groups are interconnected via the network 100. However, the two server groups can be interconnected via the Internet 110. The content printing system 1000 includes a print relay server 102. The print relay server 102 is connected to the network 100 that is connected to the Internet 110. The apparatuses and the server groups included in the content printing system 1000 can be interconnected via the Internet 110 to communicate data with each other. The number of apparatuses can be one or plural. There is a plurality of server groups. However, the number of server groups can be one.

An information terminal operated by a user corresponds to the client computer 104. A print relay system corresponds to the print relay server 102. A printing service system that generates print data based on contents instructed to be printed via the information terminal operated by the user corresponds to the print server group 103. An image forming apparatus that outputs image data based on the print data corresponds to the image forming apparatus 101.

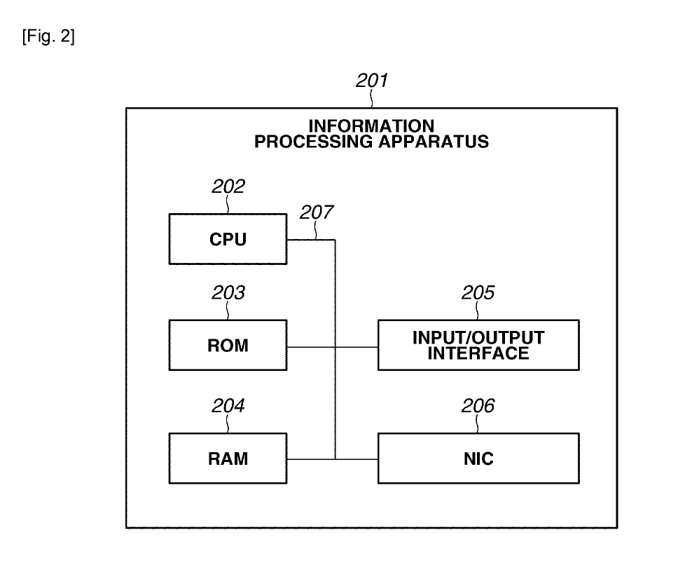

Next, a hardware configuration of the apparatuses and the server groups included in the content printing system 1000 is described. FIG. 2 illustrates the hardware configuration of the apparatuses and the server groups included in the content printing system 1000. An information processing apparatus 201 is one of the apparatuses or the server groups included in the content printing system 1000. A Central Processing Unit (CPU) 202 executes various programs to realize various functions. A Read Only Memory (ROM) 203 stores various programs. The CPU 202 loads the programs stored in the ROM 203 to a Random Access Memory (RAM) 204 to execute them. The RAM 204 is also used as a temporary work storage area of the CPU 202.

An Input/Output interface 205 transmits data to a display (not illustrated) connected to each of the apparatuses and the server groups, and receives data from a pointing device (not illustrated). A Network Interface Card (NIC) 206 connects each of the apparatuses and the server groups of the content printing system 1000 to the network 100. These units can perform transmission and reception of data via a bus 207.

A printing unit (not illustrated) mounted on the image forming apparatus 101 can transmit and receive data to and from each unit via the bus 207. The printing unit can print a raster image that is image data in a recording medium.

Next, functions of the apparatuses and the server groups included in the content printing system 1000 are described. FIG. 3 illustrates a software configuration of the apparatuses and the server groups included in the content printing system 1000. Programs to realize functions of respective software components illustrated in FIG. 3 are stored in the ROMs 203 of the respective apparatuses and server groups. The CPU 202 loads the programs to the RAM 204 to execute them, thereby realizing the functions.

The functions of the apparatuses and the server groups are described. The functions described are classified into the following two types. A first is a registration type which includes functions of registering the image forming apparatus 101 in the print relay server 102, realizing a relay virtual printer 303 in the print relay server 102, and registering the relay virtual printer 303 in the printing service 304. A second is a printing type which includes functions of transmitting a printing instruction of contents generated by the web application server group 105 to the print server group 103, and printing print data transmitted from the print server group 103 by the image forming apparatus 101. When the print data transmitted from the print server group 103 is printed by the image forming apparatus 101, the print server group 103 transmits the print data to the image forming apparatus 101 via the print relay server 102 acting as an intermediary, and the image forming apparatus 101 prints the print data.

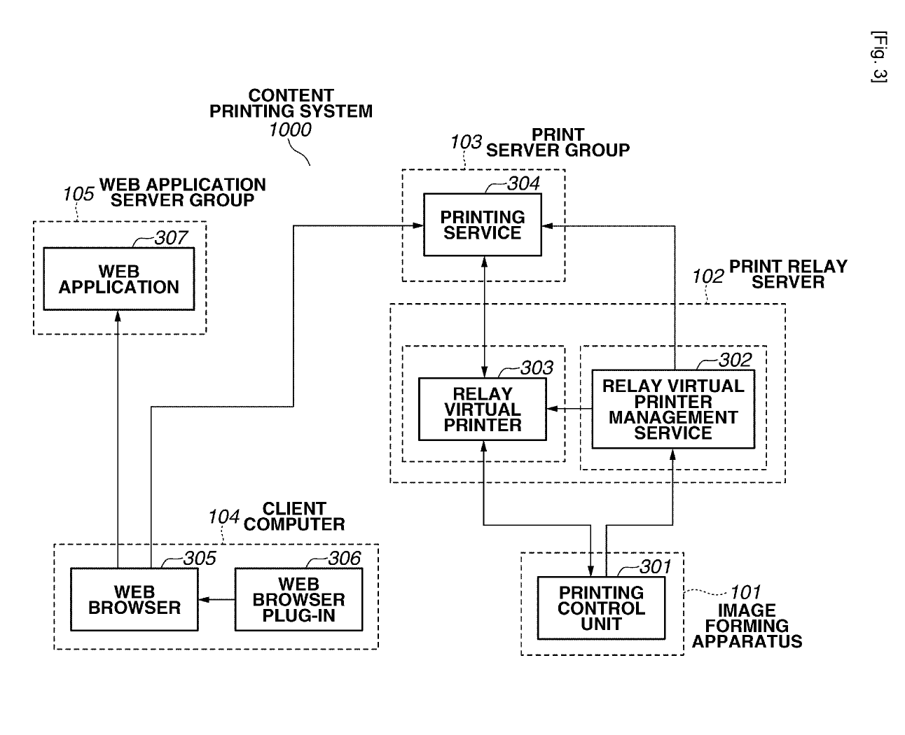

First, the functions classified in the registration type are described. The functions of the image forming apparatus 101 classified as the registration type are described. The image forming apparatus 101 includes a printing control unit 301. The printing control unit 301 realizes functions illustrated in FIG. 4. A display unit 401 displays various screens. A printing service information storage unit 402 includes information of printing services.

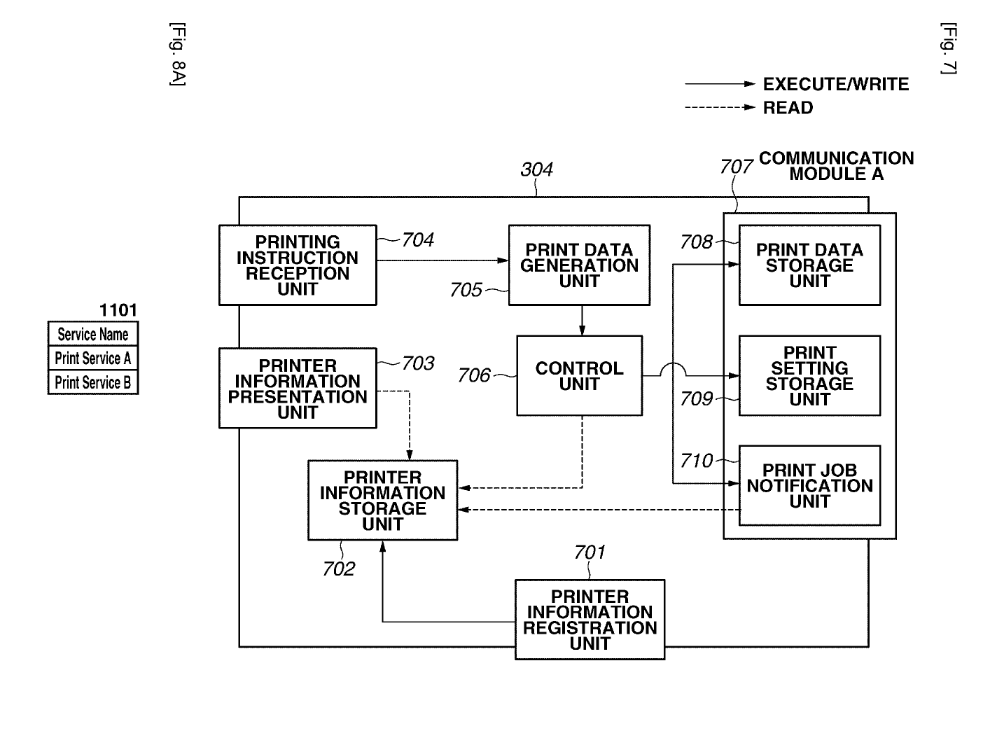

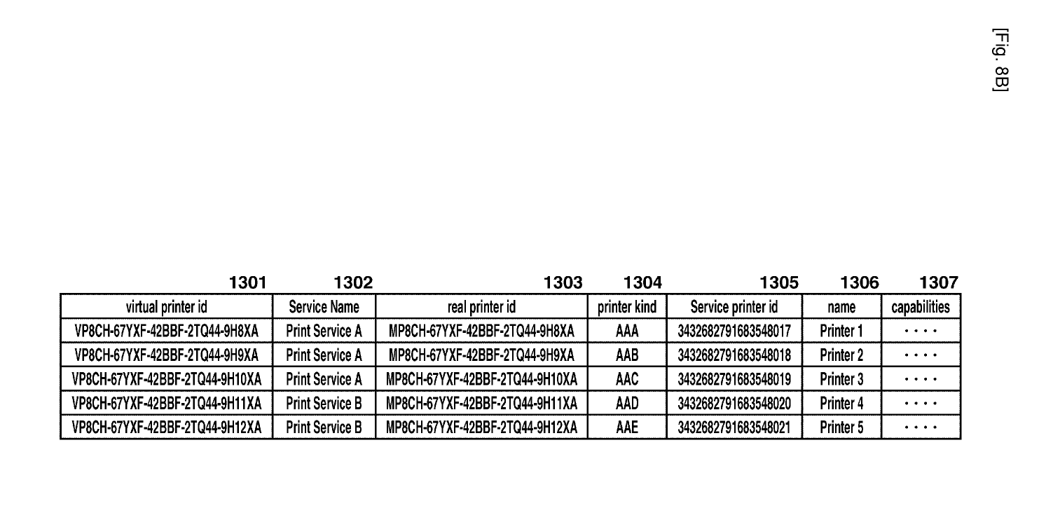

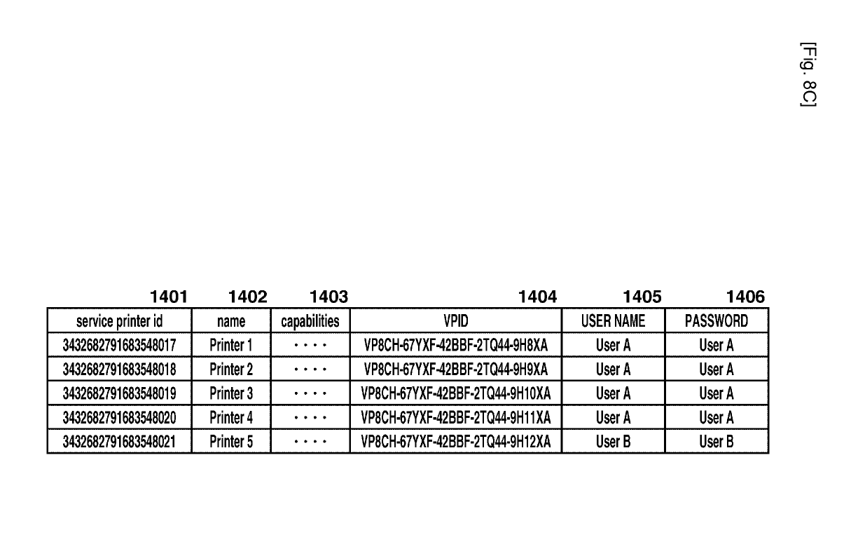

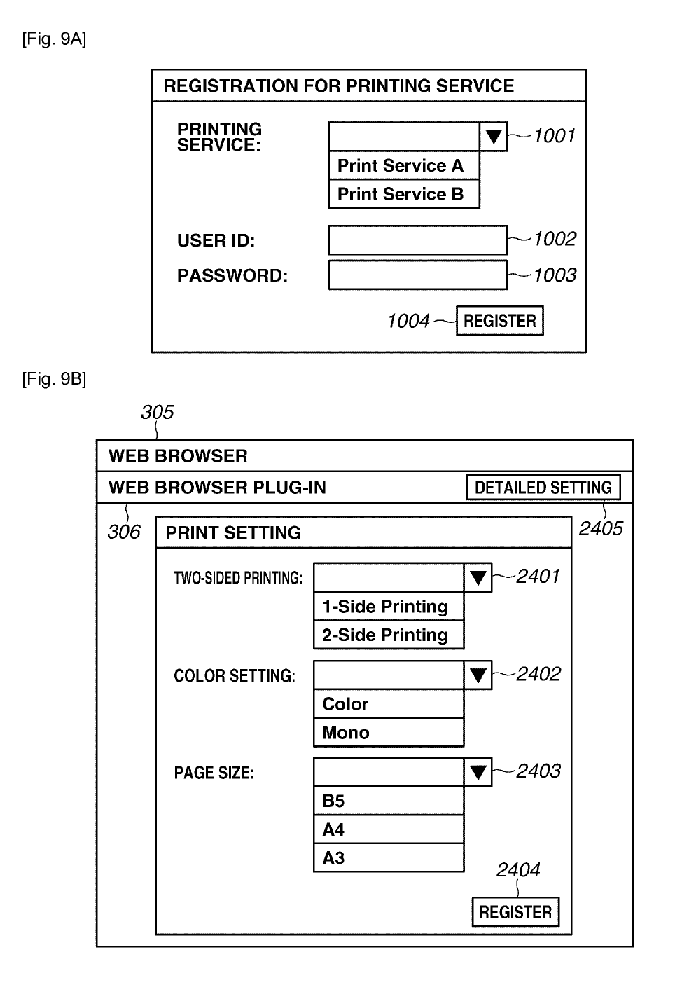

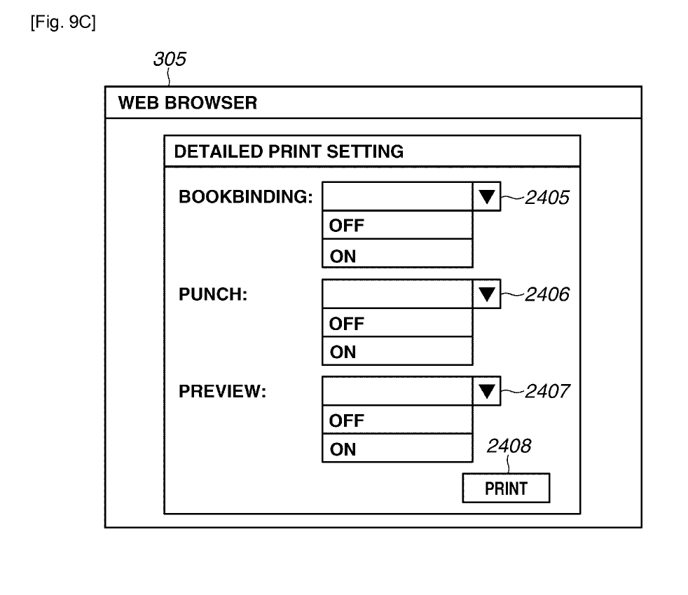

FIG. 8A illustrates the information of the printing services. In FIG. 8A, information regarding a plurality of printing services is included. The printing service 304 in the first exemplary embodiment corresponds to Print Service A. The display unit 401, when instructed to register the image forming apparatus 101 in the printing service 304 by the user, generates and displays a registration UI as illustrated in FIG. 9A based on the information illustrated in FIG. 8A. On a screen illustrated in FIG. 9A, the user selects a printing service to register the image forming apparatus 101 from a filed 1001. In the first exemplary embodiment, the printing service is only one, namely, the printing service 304, and hence the user cannot select services other than the Print Service A.

The user inputs a user identification (ID) and a password of the selected printing service to fields 1002 and 1003 respectively, and presses a registration button 1004. A registration unit 403 issues registration information in response to user's pressing of the registration button. The registration unit 403 transmits the issued registration information to a request reception unit 501 included in a relay virtual printer 303 described below. Other functions not described here are described below.

The registration information is described. The registration information contains a printing service name. The printing service name is information to identify a printing service selected by the user, specifically, the printing service 304 of the print server group 103. The registration information contains a user ID and a password. The user ID and the password are information necessary for using the printing service 304 and the web application server group 105. Such information is referred to as user information.

It is presumed that the same vendor provides the web application server group 105 and the print server group 103. Hence, when using services provided from both server groups, the user can receive both services based on the same user information. In the first exemplary embodiment, the user resister the user information in the web application server group 105 beforehand.

The registration information further contains Real Printer ID (RPID) that is unique identification information allocated to the image forming apparatus 101. Each unique identification information is allocated to each of image forming apparatuses (not illustrated) including the image forming apparatus 101. Thus, each of the image forming apparatuses can be identified by the identification information. In the first exemplary embodiment, identifying RPID enables identification of a location of the image forming apparatus.

The registration information further contains PrinterKind that is model information of the image forming apparatus 101. Concerning the model information, the same model information is allocated to the same model. When two image forming apparatuses are similar in model, it means that the same communication module B′ is mounted each of them. The communication module B′, a communication module A, a communication module A′, and a communication module B are described in detail below.

The registration information further contains a printer name of the image forming apparatus 101. The printer name is a name allocated to the image forming apparatus 101 and is used when the image forming apparatus 101 is referred to. Different from the identification information, printer names of the image forming apparatuses may be similar. The registration information further contains capabilities.

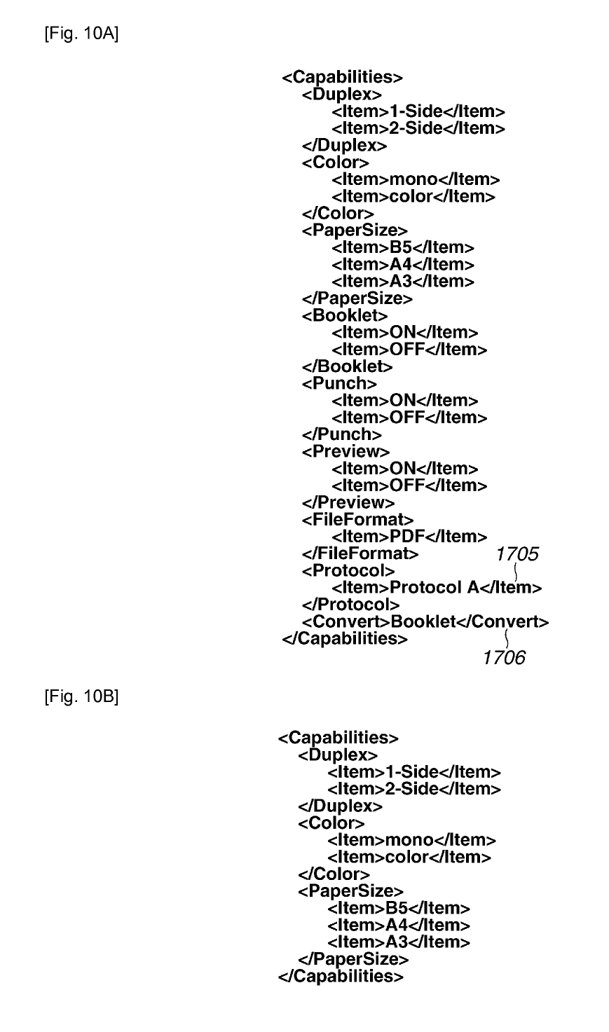

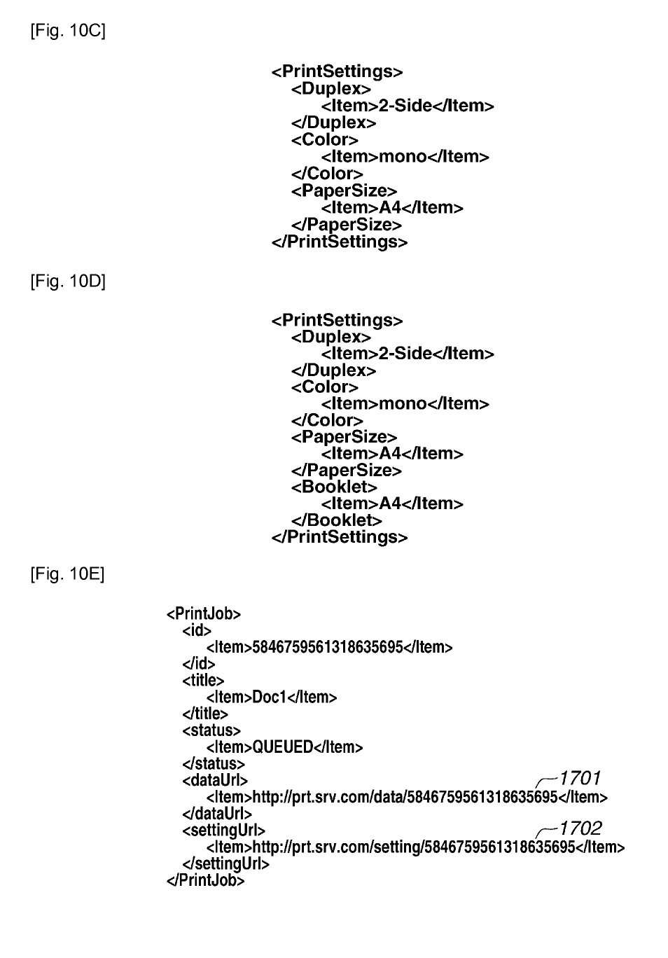

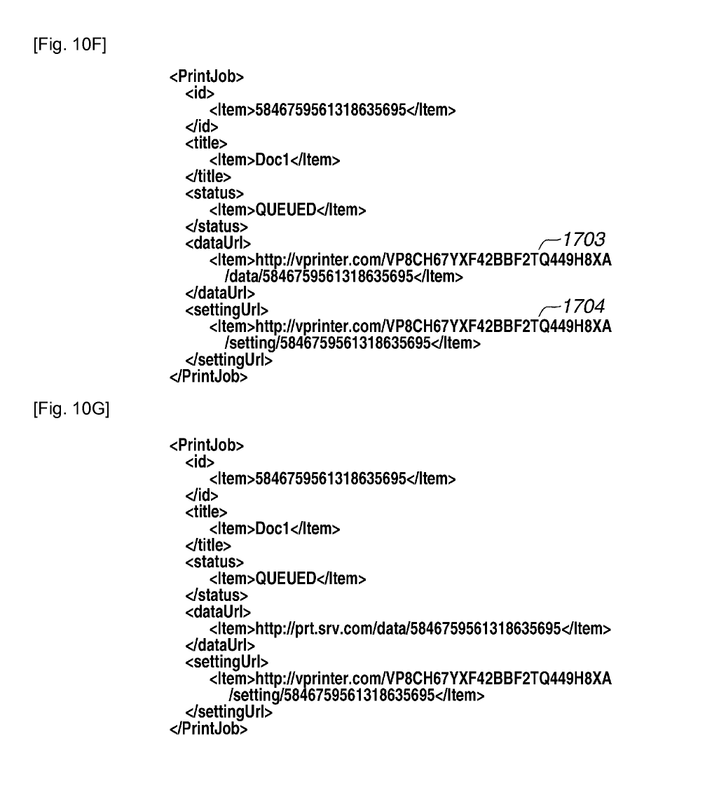

The capabilities include information pieces about, for example, whether the image forming apparatus 101 can execute two-sided printing, whether it can execute color printing, whether it can execute bookbinding printing, and a sheet size to be output. The capabilities are transmitted to the request reception unit 501 in an XML format as illustrated in FIG. 10A. <Item> illustrated in FIG. 10A indicates capabilities of the image forming apparatus 101. In FIG. 10A, it is indicated that the image forming apparatus 101 can execute imposition printing, color outputting, output in B5, A4, and A3 side sheets, bookbinding printing, and punch and preview setting.

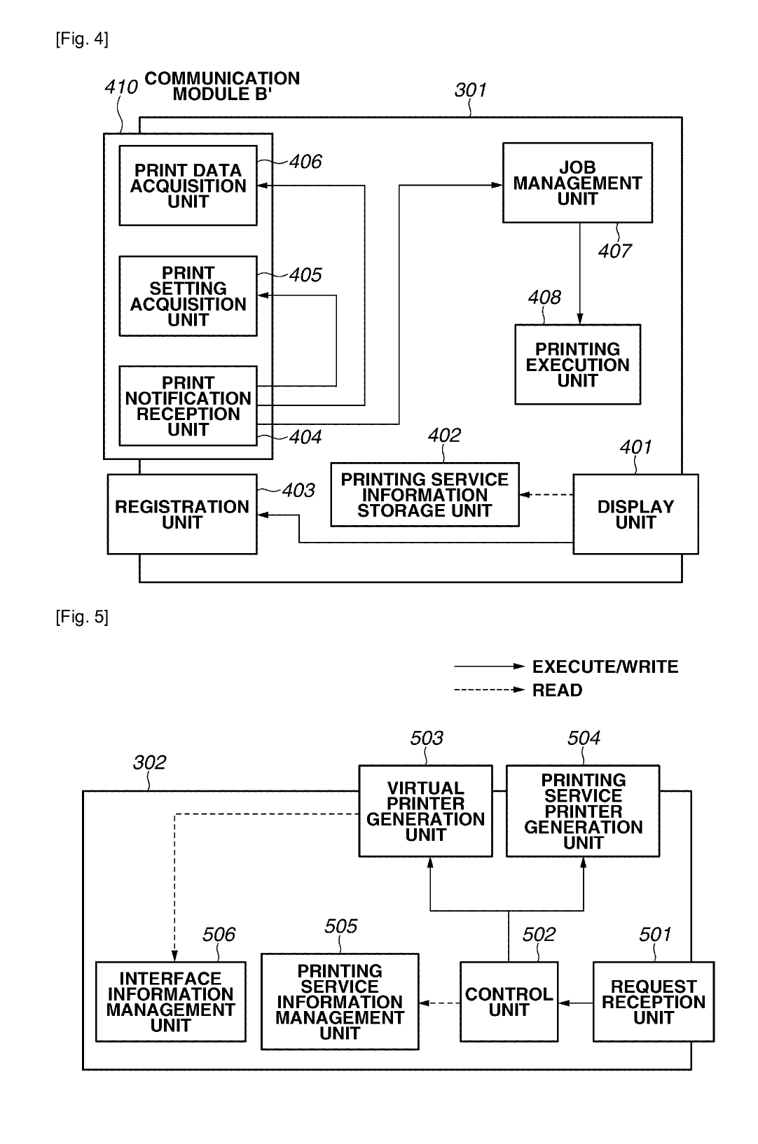

Next, functions of the print relay server 102 classified as the registration type are described. The print relay server 102 includes a relay virtual printer management service 302. The relay virtual printer management service 302 realizes functions illustrated in FIG. 5. The request reception unit 501 receives the registration information. A control unit 502 acquires the registration information received by the request reception unit 501, and interprets the registration information.

The control unit 502 instructs a virtual printer generation unit 503 and a printing service printer generation unit 504 to execute the following two processes. The first process is to realize a function of the relay virtual printer 303 by the virtual printer generation unit 503. The second process is to register information of the relay virtual printer 303 in the printing service 304 by the printing service printer generation unit 504.

The first process to realize the function of the relay virtual printer 303 by the virtual printer generation unit 503 is described. The relay virtual printer 303 realizes functions illustrated in FIG. 6, which is described in detail below. The virtual printer generation unit 503 identifies and acquires a communication module B 602 stored in an interface information management unit 506 based on PrinterKind transmitted from the control unit 502.

The virtual printer generation unit 503 identifies and acquires a communication module A′ 601 stored in the interface information management unit 506 based on a printing service name. The communication module B is a module for communicating with the image forming apparatus 101. The same model has the same communication module B as described above, and hence the communication module B can be identified from the PrinterKind. The communication module B communicates with a communication module B′ 410 of the printing control unit 301. The communication module A′ 601 is a module for communicating with the print server group 103 and can communicate with a communication module A 707 of the printing service 304. The virtual printer generation unit 503 that has acquired the two communication modules realizes a process (thread) where the two communication modules have been loaded. This process corresponds to the relay virtual printer 303.

The virtual printer generation unit 503 that has realized the relay virtual printer 303 issues Virtual Printer ID (VPID) that is identification information to identify the realized relay virtual printer 303. The issued VPID is transmitted to the control unit 502. The relay virtual printer 303 is realized for each transmission of the registration information of the image forming apparatus 101, and VPID that is a unique identifier is allocated to each realized relay virtual printer. In the first exemplary embodiment, identifying the VPID enables identification of a location of the relay virtual printer.

Next, the second process to register the information of the relay virtual printer 303 in the printing service 304 by the printing service printer generation unit 504 is described. The control unit 502 transmits the user information to the printing service printer generation unit 504. The printing service printer generation unit 504 authenticates the printing server group 103 based on the received user information. When the authentication is successful, the printing service printer generation unit 504 transmits a printer name, capabilities (FIG. 10B) processable by the printing service 304, and the VPID to the printing service 304. The printing service printer generation unit 504 receives Service Printer ID (SPID) as a response. The SPID is described below.

A reason why the print setting illustrated in FIG. 10A cannot be registered in the printing server group 103 is described. The reason is that a vender managing the printing server group 103 cannot sufficiently utilize the functions of the image forming apparatus 101. The vender managing the printing server group 103 and a vendor producing the image forming apparatus 101 are different. A mechanism of the image forming apparatus 101 is not sufficiently revealed to the former vendor. Thus, the vendor managing the printing server group 103 cannot provide any function regarding use of partial functions of the image forming apparatus 101. However, the content printing system 1000 has an advantage that separating a printing service and a print relay service enables division of labor for service development.

The control unit 502 acquires the VPID and the SPID from the virtual printer generation unit 503 and the printing service printer generation unit 504. The control unit 502 that has acquired the VPID and the SPID instructs the printing service information management unit 505 to store these information pieces. The printing service information management unit 505 stores the VPID, the SPID, and the registration information in association with each other as illustrated in FIG. 8B. The VPID corresponds to data in a column 1301. The printing service name corresponds to data in a column 1302. The RPID corresponds to data in a column 1303. The PrinterKind corresponds to data in a column 1304. The SPID corresponds to data in a column 1305. The printer name corresponds to data in a column 1306. The capabilities correspond to data in a column 1307.

Next, functions of the print server group 103 classified as the registration type are described. The print server group 103 includes the printing service 304. In the print server group 103, a plurality of servers is virtualized into one server, which realizes the functions of the printing service 304. In the print server group 103, a plurality of virtual machines is activated in the one server, and the function of the printing service 304 is realized for each virtual machine. FIG. 3 illustrates one such printing service 304.

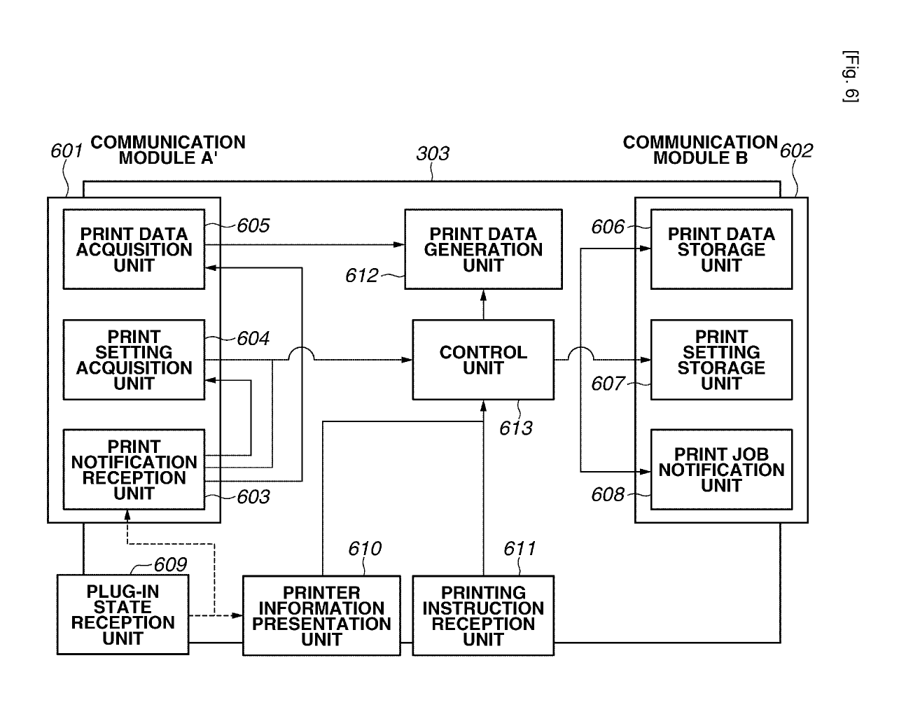

The printing service 304 realizes functions illustrated in FIG. 7. A printer information registration unit 701 receives user information from the printing service printer generation unit 504. The printer information registration unit 701 reads the user information stored by the web application 306 of the web application server group 105, and checks whether the received user information is present. When present, determining that authentication has been successful, the printer information registration unit 701 receives a printer name, capabilities, and VPID from the printing service printer generation unit 504, and instructs a printer information storage unit 702 to store the received VPID.

The printer information registration unit 701 issues SPID corresponding to the VPID, and transmits the issued SPID to the printer information storage unit 702 and the printing service printer generation unit 504. The printer information storage unit 702 stores the printer name, the capabilities, the VPID, the SPID, a user ID, and a password in association with each other. FIG. 8C illustrates information stored in the printer information storage unit 702, namely, the SPID, the printer name, the capabilities, the VPID, the user ID and the password corresponds to data pieces in columns 1401, 1402, 1403, 1404, 1405, and 1406 respectively. Other functions not described here are described below. The functions described above are classified as the registration type, which registers the image forming apparatus 101 in the print relay server 102, realizes the relay virtual printer 303 in the print relay server 102, and registers the relay virtual printer 303 in the printing service 304.

Next, the functions classified as the printing type are described. First, functions of the client computer 104 are described. The client computer 104 includes a web browser 305. The web browser 305 includes a web browser plug-in 306. The web browser plug-in 306 is an extension function for the web browser 305.

The web browser 305 transmits a printing instruction of contents stored in the web application server group 105 to the web application server group 105. The web browser 305 receives an access command, namely, a redirection instruction to the print server group 103 from the web application group 105, and accesses the print server group 103 according to the received redirection instruction.

The web browser 305 acquires from the accessed print server group 103, a list of image forming apparatuses that a user of the web browser 305 can use for printing and displays the list. The web browser 305 acquires from the print server group 103, a print setting screen corresponding to an image forming apparatus selected from the list by the user and displays the print setting screen.

FIG. 9B illustrates the print setting screen corresponding to the image forming apparatus selected by the use and the web browser plug-in 306, which are displayed by the web browser 305. The web browser 305 transmits a print setting value set on the print setting screen by the user to the print server group 103.

The web browser plug-in 306 displays a screen for instructing ON/OFF as to execution of detailed print setting. In the present exemplary embodiment, a button form 2405 illustrated in FIG. 9B is employed. However, only required is a screen for instructing whether the user executes the detailed print setting by a check box or other methods. The web browser plug-in 306 detects transmission of the print setting value set by the user to the print server group 103, and transmits setting information (ON/OFF values of detailed setting buttons) and the SPID of the web browser plug-in 306 to the relay virtual printer 303.

Polling is then executed to check whether the relay virtual printer 303 has received a printing notification from the print server group 103. At the time of polling, checking is executed based on the SPID corresponding to the selected image forming apparatus. When the web browser plug-in 306 receives the detailed print setting screen from the relay virtual printer 303, the web browser plug-in 306 transmits screen information to the web browser 305 to display the detailed print setting screen by web browser 305. The web browser plug-in 306 transmits a detailed print setting value set on the detailed print setting screen by the user to the relay virtual printer 303. The web browser 305 and the web browser plug-in 306 included in the client computer 104 have been described.

Next, functions of the web application server group 105 are described. The web application server group 105 includes a web application 307. In the web application server group 105, a plurality of servers is virtualized into one server, which realizes the functions of the web application 307. In the web application server group 105, a plurality of virtual machines is activated in the one server, and the function of the web application 307 is realized for each virtual machine.

The web application 307 provides a document creation service. For example, when wishing to distribute materials at a conference of a company, the user uses the document creation service to create the materials. When the client computer 104 uses the web application 307, the application does not need to be installed in the client computer 104. It is only required to install the web browser 306 and the web browser 305.

The web application 307 transmits screen information to create the materials to the web browser 305. The web application 307 executes authentication based on the user information containing the user ID and the password input by the user via the web browser 305, and transmits the screen information to create the materials when the authentication is successful.

The web browser 305 that has received the screen information displays a creation screen to create documents based on the screen information, and the user creates the materials to be distributed at the conference using the creation screen. The web application 307 receives information of the materials created by the user using the creation screen, creates contents based on the received information, and stores the created contents in a storage device of the web application server group 105. The web application 307 provides a mail service and a schedule service in addition to the document creation service.

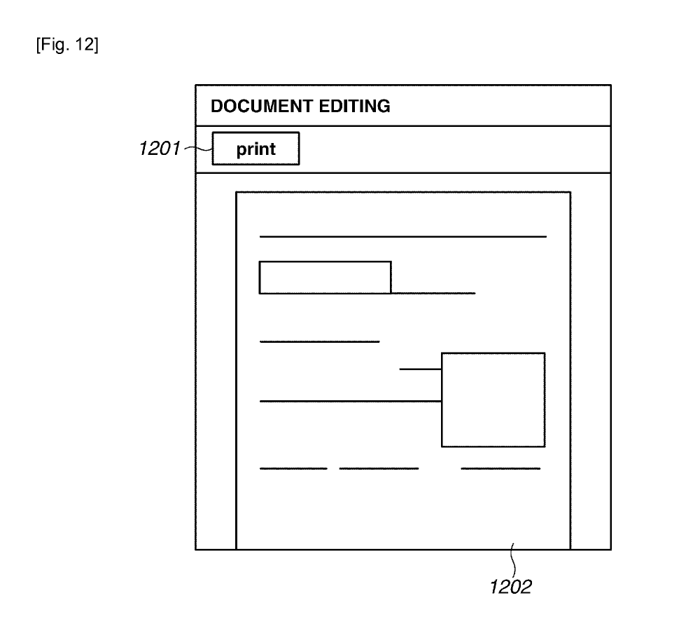

The user wishing to print the contents created by the document creation service presses a print button displayed on the creation screen. FIG. 12 illustrates a state in which a print button 1201 is pressed. The user has created contents 1202.

The web application 307 receives information indicating that the print button is pressed, and transmits an access command to the print server group 103, namely a redirection instruction to the web browser 305. The redirection instruction contains an acquisition request of a list corresponding to the user using the web browser 305, content identification information to identify contents instructed to be printed by the user, and the user information.

If a content acquisition request is made from the print server group 103, the web application 307 transmits target contents to the print server group 103 based on the content identification information to identify the contents which is transmitted with the acquisition request. The web application 307 of the web application server group 105 has been described.

Next, functions of the print server group 103 classified as the printing type are described. As illustrated in FIG. 7, the printing service 304 of the print server group 103 includes a printer information presentation unit 703. In response to the reception of the list acquisition request from the web browser 305, the printer information presentation unit 703 transmits a list to the web browser 305. The printer information presentation unit 703 identifies SPID and a printer name stored in a printer information storage unit 702 based on the user information. The printer information presentation unit 703 generates a list of image forming apparatuses that the user can use based on the SPID and the printer name.

Further, the printer information presentation unit 703 receives SPID of a symbol corresponding to an image forming apparatus selected from the list by the user. The symbol means an icon of the image forming apparatus displayed in the list. The printer information presentation unit 703 identifies capabilities stored in the printer information storage unit 702 based on the received SPID, generates a print setting screen, and transmits the generated print setting screen to the web browser 305.

The printer information storage unit 702 generates the print setting screen as illustrated in FIG. 9B based on information of the capabilities illustrated in FIG. 10B. As illustrated in FIG. 9B, the printer information storage unit 702 generates the print setting screen on which print settings described in the capabilities processable by the printing service 304 are only selectable.

A printing instruction reception unit 704 receives the print setting set via the print setting screen and the SPID from the web browser 305. The printing instruction reception unit 704 receives, when accessed by the web browser 305 according to the redirection instruction, the content identification information to identify the contents instructed to be printed by the user.

A print data generation unit 705 receives the content identification information from the printing instruction reception unit 704, and acquires the contents to be printed from the web application 307 based on the received content identification information. The print data generation unit 705 receives the print setting input by the user and the SPID corresponding to the image forming apparatus selected by the user from the printing instruction reception unit 704. The print data generation unit 705 converts the contents into print data based on the contents and the print setting acquired from the web application 307.

A control unit 706 acquires the print data, the print setting, and the SPID from the print data generation unit 705. The print setting is described in an XML format as illustrated in FIG. 10C. As illustrated in FIG. 10C, the user has set two-sided printing, monochrome setting, and a sheet size A4. The communication module A 707 can communicate with an apparatus that includes the communication module A′ 601 and is an interface for data communication therebetween. The communication module A′ 601 cannot communicate with the communication module A 707. A reason is described below after description of functions of the communication module A 707.

The communication module A 707 includes a print data storage unit 708, a print setting information storage unit 709, and a print job notification unit 710. The print data storage unit 708 receives and stores the print data from the control unit 706. The print setting information storage unit 709 receives and stores the print setting from the control unit 706. The print data storage unit 708 and the print setting information storage unit 709 receive storage instructions from the control unit 706 to store the data.

The control unit 706 instructs, upon receiving a message indicating that the print data storage unit 708 and the print setting information storage unit 709 have stored the data, a print job notification unit 710 to transmit notification information. Having been instructed by the control unit 706 to transmit the notification information, the print job notification unit 710 acquires the SPID from the control unit 706, and indentifies the VPID based on the information stored in the printer information storage unit 702.

Information of a transmission destination corresponding to the SPID, namely, the

VPID according to the first exemplary embodiment is referred to as a target. The user designates the VPID by selecting the SPID. The print job notification unit 710 acquires a storage place of the print data and a storage place of the print setting from the control unit 706 to generate notification information A, and transmits the notification information A to the registered image forming apparatus. The print job notification unit 710 corresponds to a first transmission unit, and the information transmitted by the print job notification unit 710 corresponds to information about data.

In the first exemplary embodiment, the information about the data is the notification information A. However, the information about the data may include other information or data according to communication specifications. The same applies to notification information B described below. In the first exemplary embodiment, the registered image forming apparatus is a relay virtual printer corresponding to the VPID. The notification information A is expressed in an XML format as illustrated in FIG. 10E and includes the descriptions of the storage place of the print data in an item 1701 and the storage place of the print setting in an item 1702.

The reason why communication modules other than the communication module A′ cannot communicate with the communication module A is described. It is because the communication modules other than the communication module A′ cannot interpret the notification information A expressed in the XML and transmitted from the print job notification unit 710.

There is another example where the communication modules other than the communication module A′ cannot communicate with the communication module A. The example is that if causing the communication module A that does not include the print job notification unit 710 to acquire the print data and the print setting by another method, the communication module A′ that acquires the notification information A cannot acquire the data. It is because the communication module A′ that acquires the notification information A is in a state of waiting for the notification information A from the communication module A, and hence the communication module A′ cannot acquire the print data and the print setting until the notification information A is notified.

The communication module A′ that can communicate with the communication module A must be configured to inquire of the communication module A about whether there is data to be acquired. No communication may be allowed between the communication module A and the communication module A′ because the communication module A′ does not comply with a data communication standard of the communication module A. A mechanism for enabling communication between the communication module A and the communication module A′ is referred to as specifications of a vendor that provides the print server group 103. The specifications greatly depend on the vendor that manages the print server group 103.

The vendor that manages the print server group 103 mounts the communication module A on the print server group 103, and releases an Application Programming Interface (API) for communicating with the communication module A. In fact, such a system has recently been established, and the vendor that manages the print server group 103 has released own specifications to execute data communication between the print server group 103 and the device.

To enable the image forming apparatus 101 to communicate with the print server group 103, the device vendor of the image forming apparatus 101 needs to install the API-mounted communication module A′ in the image forming apparatus 101. It is presumed that the vendor managing the print server group 103 has changed the configuration of the communication module A. In other words, it is presumed that the vendor managing the print server group 103 has changed the specifications. Due to the change of the specifications, the device vendor needs to change the communication module A′ of the image forming apparatus 101. This work imposes a great burden.

It is because the image forming apparatus is located in various client environments and, hence, to enable the image forming apparatuses to communicate with the print server group 103 again, a service engineer needs to visit various client environments to change the communication module A′. A solution by distributing the communication module A′ without using any service engineer can be employed. However, the communication module A′ needs to be distributed to a plurality of image forming apparatuses, which imposes loads on a communication band.

However, use of the functions of the print relay sever 102 classified as the printing type describe below can solve the issue. The data communication specifications released by the vendor managing the printer server group 103 corresponds to first specifications. Interfaces for the communication module A and the communication module A′ are created according to the first specifications.

Next, the functions of the print relay sever 102 classified as the printing type are described. The functions illustrated in FIG. 6 are realized. The relay virtual printer 303 includes the communication module A′ 601 and the communication module B 602. A print notification reception unit 603 of the communication module A′ 601 receives the notification information A transmitted from the print job notification unit 710. In the printing service 304, not the RPID of the image forming apparatus 101 but the relay virtual printer 303 has been registered, and hence the notification information A is transmitted to the print notification reception unit 603.

The communication module A′ makes a pair with the communication module A, and hence the print notification reception unit 603 can interpret the notification information A. The print notification reception unit 603 corresponds to a first acquisition unit. The print notification reception unit 603 checks the storage place of the print data and the storage place of the print setting described in the notification information A, and notifies a print setting acquisition unit 604 and a print data acquisition unit 605 of each information. The print setting acquisition unit 604 acquires the print setting from the print setting storage unit 709 based on the notified storage place of the print setting.

A plug-in state reception unit 609 receives plug-in setting information and SPID transmitted from the web browser plug-in 306, and notifies a control unit 613 of them. Then, a printer information presentation unit 610 receives an inquiry from the web browser plug-in 306 to notify the control unit 613 of it.

The control unit 613 identifies capabilities illustrated in FIG. 10A based on the plug-in setting information and the received SPID, and determines whether the print data acquisition unit 605 needs to acquire the print data from the print server group 103. The determination is described below. When the acquisition is necessary, the printer information presentation unit 610 generates a detailed print setting screen, and transmits the generated detailed print setting screen illustrated in FIG. 9C to the web browser 305. A screen for setting detailed print setting which cannot be set on the print setting screen provided by the printing service system corresponds to the detailed print setting screen illustrated in FIG. 9C.

The detailed print setting screen generated in this case is for enabling selection of print settings unprocessable by the printing service 304. The print settings unprocessable by the printing service 304 means capabilities not generated as print setting screens by the printer information presentation unit 703, namely, differences between FIG. 10A and FIG. 10B. The difference capabilities are multifunction peripheral (MFP) vendor's own functions which are not released to the vendor that manages the print server group 103 or not prepared in the print server group 103. The user can select more print settings on the detailed print setting screen displayed in the web browser 305.

Then, the print instruction reception unit 611 receives detailed print setting information. The print data acquisition unit 605 acquires the print data from the print data storage unit 708 based on the notified storage place of the print data to notify the control unit 613 of it. The control unit 613 instructs a print data generation unit 612 to store the print data acquired by the print data acquisition unit 605. The print setting storage unit 607 that has stored the print setting notifies the control unit 613 of the storage place.

Upon receiving a notification of the storage places from the print data storage unit 606 and the print setting storage unit 607, the control unit 613 generates notification information B. The notification information B is expressed in an XML format as illustrated in FIG. 10F. The storage place of the print data is described in an item 1703, and the storage place of the print setting is described in an item 1704. The control unit 613 instructs a print job notification unit 608 to transmit the notification information B to the printing control unit 301. The print job notification unit 608 transmits the notification information B to the printing control unit 301.

When the print data acquisition unit 605 determines that it is not necessary to acquire the print data from the print server group 103, the control unit 613 generates notification information C in response to reception of a notification from the print notification reception unit 603. The notification information C is expressed in an XML format as illustrated in FIG. 10G. The storage place of the print data is described in the item 1703, and the storage place of the print setting is described in the item 1704. In this case, the storage place of the data indicates not the storage place of the relay virtual printer 303 but the storage place of the printing service 304 described in the notification information A.

Referring to FIG. 16, determination executed by the print data acquisition unit 605 as to whether to acquire the print data from the print server group 103 is described. In step S1601, the print data acquisition unit 605 checks whether the image forming apparatus 101 includes a communication module B′ 501 and is able to communicate with the communication module A. This determination is made by comparing communication protocol information 1705 of the capabilities of the image forming apparatus illustrated in FIG. 10A with specifications of the communication module A.

It is because no API defined by the printing service 304 may be mounted depending on a model or capabilities of the image forming apparatus, and the relay virtual printer 303 needs to change the communication protocol. In the capabilities that are the registration information of the image forming apparatus 101 illustrated in FIG. 10A, when communication can be executed with the printing service 304, the relay virtual printer 303 may not need to acquire the print data from the print server group 103.

In step S1602, the print data acquisition unit 605 determines whether the printing instruction reception unit 611 needs to receive detailed print setting information to convert image information of the print data. A reason for this determination is described. It is presumed that bookbinding printing has been designated in the detailed print setting, and the printing service 304 has generated print data of an image layout of 1 in 1. However, with the print data of this layout, the user cannot acquire a desired output result. Thus, the print data generation unit 612 needs to acquire print data output from the print server group 103 to lay it out again. When the user does not execute the detailed print setting, a configuration where no print data is acquired from the print server group 103 can be employed. In this case, a step of checking the detailed print setting can be omitted.

Based on the registration information defined in the capabilities illustrated in FIG. 10A, determination is made as to in which ON setting the print data needs to be converted. In the image forming apparatus 101 having the capabilities illustrated in FIG. 10A, the bookbinding setting is expressed as a function 1706 where an image needs to be converted. Thus, when the user executes bookbinding setting on the detailed setting screen, in step S1520 described below, print setting is received from the printing service 304 to generate XML data to which bookbinding setting information is added illustrated in FIG. 10D.

In the present exemplary embodiment, though not illustrated, as examples of print settings where an image layout needs to be changed, there are a magnification of an output size, a direction, and a resolution change. Whether the print data needs to be converted is determined by recognizing such print setting.

In step S1603, the print data acquisition unit 605 determines whether a preview has been selected in the detailed print setting information. Its purpose is to generate a preview image reflecting the print setting or the detailed print setting. A preview function is an additional function provided by the print relay server 102. To provide the preview image to the user from the print relay server 102, actual print data is necessary. Step S1603 is accordingly set.

In step S1604, the print data acquisition unit 605 determines whether the image forming apparatus 101 can interpret the print data. If the image forming apparatus cannot render a print data format generated by the printing service 304 due to the model or the capabilities of the image forming apparatus, the print data generation unit 612 converts the print data so that the image forming apparatus can interpret the data. The above-described step is set assuming that the image forming apparatus 101 cannot interpret the print data depending on its type.

When these conditions are satisfied, the print data generation unit 612 does not need to convert the print data of the printing service 304. Hence, it is determined that the relay virtual printer 303 does not need to acquire print data. There is no restriction on an execution order of the steps illustrated in FIG. 16, nor all the steps are necessary. The flowchart in FIG. 16 according to the first exemplary embodiment illustrates an example of using the print relay server with a plurality of determination steps to provide results desired by the user as much as possible.

The print job notification unit 608 corresponds to a second transmission unit. Thus, the former communication module A′ 601 transmits the print data and the print setting to the latter communication module B 602 to realize inter-module communication. The communication module B′ corresponding to the communication module B is mouthed on the image forming apparatus 101.

As described above, the image forming apparatus 101 is configured to acquire print job notification from the print server group 103 via the print relay server 102. The image forming apparatus 101 is configured to acquire the print job from the print data storage place described in the job notification information. Thus, even when the print data is present in any one of the relay virtual printer 303 and the printing service 304, the image forming apparatus 101 can acquire the print data. In other words, since the print data is acquired in the relay virtual printer 303 only when necessary, loads on the relay virtual printer 303 can be reduced.

Next, the functions of the image forming apparatus 101 classified as the printing type are described. As illustrated in FIG. 4, the printing control unit 301 includes the communication module B′ 410. A print notification reception unit 404 of the communication module B′ 410 receives the notification information B or the notification information C transmitted from the print job notification unit 608. The print notification reception unit 404 corresponds to a second acquisition unit. The communication module B′ makes a pair with the communication module B, and hence the print notification unit 404 can interpret the notification information pieces B and C.

Specifications defined by the device vendor to enable the image forming apparatus 101 to communicate with the relay virtual printer 303 or the printing service 304 corresponds to second specifications, and can be handled by the device vendor. An interface for the communication module B and the communication module B′ is created according to the second specifications.

The print notification reception unit 404 checks the storage place of the print data described in the notification information B, and notifies a print setting acquisition unit 405 and a print data acquisition unit 406 of each information. The print setting acquisition unit 405 acquires the print setting from the print setting storage unit 607 based on the notified storage place of the print setting. The print data acquisition unit 406 acquires the print data from the print data storage unit 607 or the print data storage unit 708 based on the notified storage place of the print data. The print setting and the print data that have been acquired are transmitted to a job management unit 407 via the print notification reception unit 404.

The job management unit 407 acquires the print data and print setting information, and instructs a printing execution unit 408 to execute printing. The printing execution unit 408 that has received the instruction generates a raster image based on the print setting and the print data, and instructs the printing unit to print the generated raster image. The printing type that transmits the printing instruction of the contents generated by the web application server group 105 to the print server group 103, and causes the image forming apparatus to print the print data transmitted from the print server group 103 has been described.

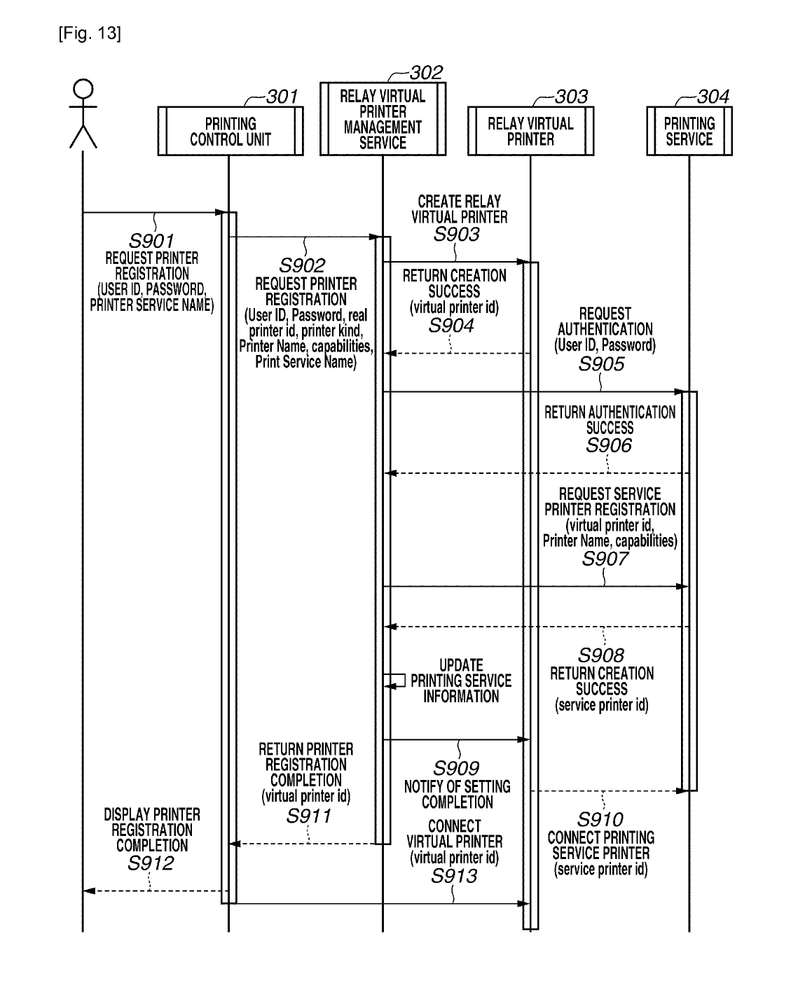

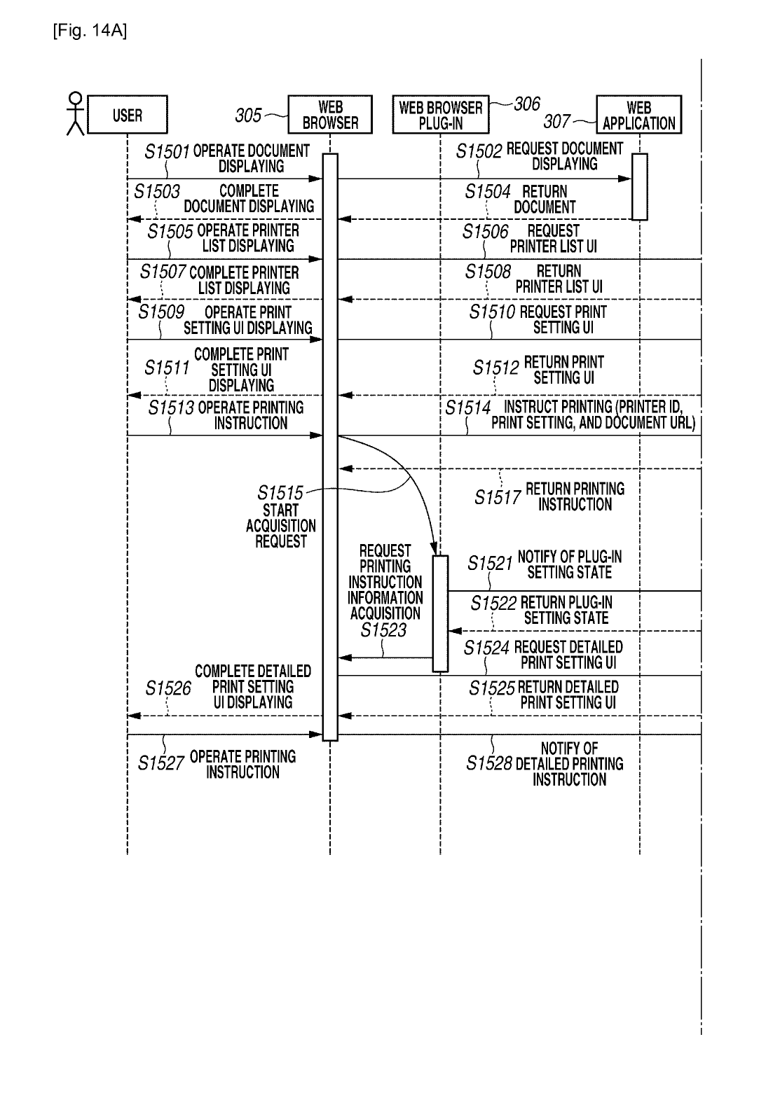

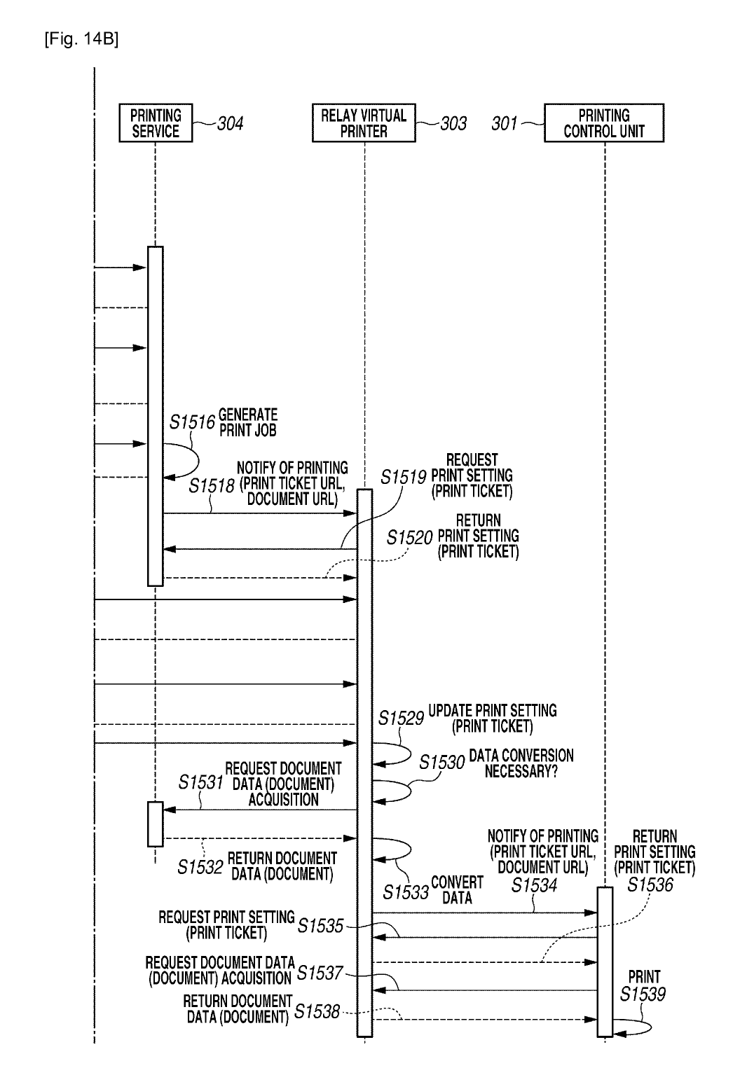

Next, referring to FIG. 13, processing for registering the image forming apparatus 101 in the print relay server 102, realizing the relay virtual printer 303 in the print relay server 102, and registering the relay virtual printer 303 in the printing service 304 is described.

First, in step S901, the user selects a printing service to register from the UI of the image forming apparatus 101 and inputs user ID and a password. In step S902, the printing control unit 301 of the image forming apparatus 101 requests the relay virtual printer management service 302 to register the printer. In this case, the printing control unit 301 transmits the above-described registration information to the relay virtual printer management service 302.

In step S903, the relay virtual printer management service 302 realizes the relay virtual printer 303 based on the registration information. In step S904, the relay virtual printer 303 transmits VPID as a response of a creation success to the relay virtual printer management service 302.

In step S905, the relay virtual printer management service 302 transmits the user ID and the password to the printing service 304 for authentication. When the authentication by the printing service 304 is successful, in step S906, the printing service 304 transmits a message indicating that the authentication has been successful to the relay virtual printer management service 302.

In step S907, the relay virtual printer management service 302 requests the printing service 304 to register the VPID as a printer (service printer) provided to the user. In step S908, having registered the VPID as the service printer, the printing service 304 issues SPID to transmit it to the relay virtual printer management service 302.

In step S909, the relay virtual printer management service 302 instructs the printer information storage unit 702 to store the SPID, and transmits a message indicating that setting has been completed to the relay virtual printer 303. In step S910, the relay virtual printer 303 connects to the communication module A of the printing service 304 based on the SPID to wait for transmission of the notification information A.

In step S911, the relay virtual printer management service 302 notifies the printing control unit 301 of registration completion of the printer. In step S912, the printing control unit 301 instructs the UI of the image forming apparatus 101 to display a message indicating registration completion of the image forming apparatus. In step S913, the printing control unit 301 connects to the relay virtual printer 303 based on the VPID to wait for transmission of the notification information B. The registration processing has been described.

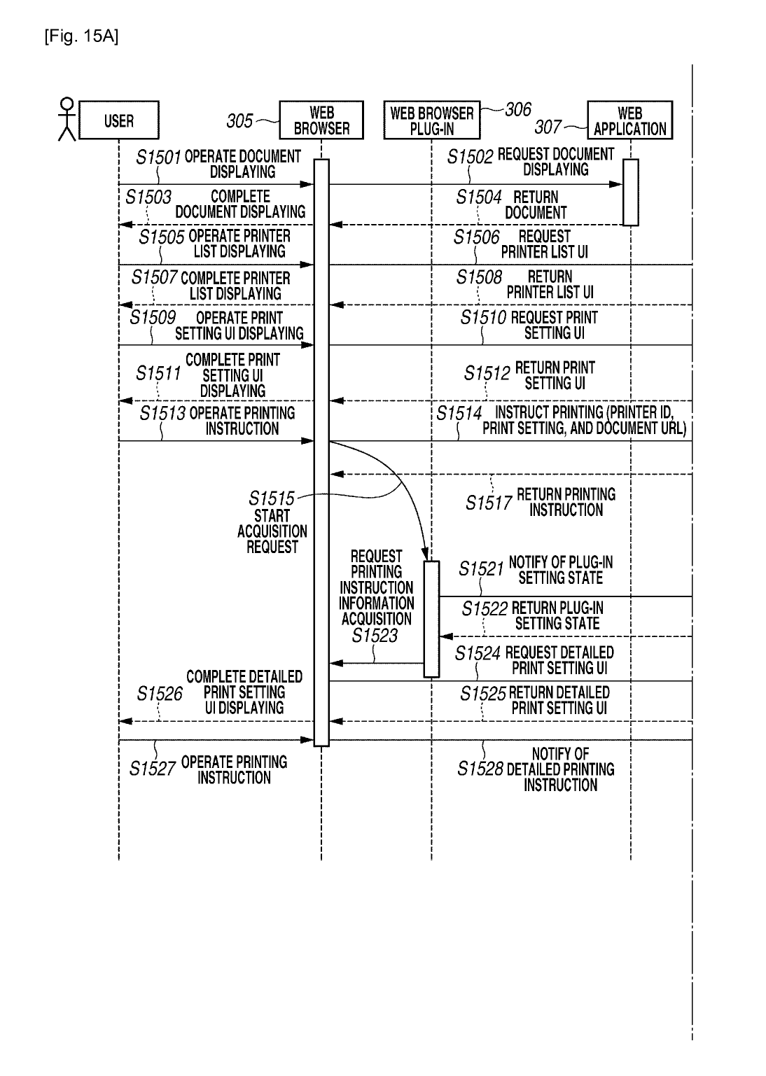

Next, referring to FIGS. 14A and 14B, processing for transmitting the printing instruction of the contents generated by the web application server group 105 to the print server group 103, and causing the image forming apparatus 101 to print the print data transmitted from the print server group 103 is described.

First, in step S1502, the web browser 305 requests the web application 307 to display the contents that the user wishes to edit. In step S1504, the web application 307 transmits a screen of contents corresponding to the requested contents to the web browser 305.

In step S1506, after reception of the printing instruction from the user via the content screen, the web browser 305 requests a list screen of image forming apparatuses (service printers) registered in the printing service 304. In step S1508, the printing service 304 transmits, to the web browser 305, the list screen of the service printers corresponding to the user using the web browser 305.

In step S1510, after the user has selected an image forming apparatus from the list screen, the web browser 305 requests a print setting screen corresponding from the selected image forming apparatus. In step S1512, the printing service 304 transmits the print setting screen to the web browser 305. In step S1514, the web browser 305 transmits the print setting input by the user via the print setting screen to the printing service 304. In step S1505, the web browser 305 causes the web browser plug-in 306 to start print information acquisition.

In step S1516, the printing service 304 acquires the contents instructed to be printed by the user from the web application 305, and converts the acquired contents into print data based on the received print setting. The printing service 304 combines the converted print data and the print setting to generate a print job.

In step S1518, the printing service 304 notifies the relay virtual printer 303 of the generation of the print job as notification information. The notification information corresponds to a printing instruction. However, when printing is not instructed based on the notification information, information regarding the print setting may correspond to a printing instruction. Thus, information for instructing printing corresponds to the printing instruction.

In step S1519, the relay virtual printer 303 requests acquisition of the print setting to the printing service 304. In step S1520, the relay virtual printer 303 acquires the print setting from the printing service 304.

In step S1522, the web browser plug-in 306 notifies, to check whether the user has requested detailed print setting to the relay virtual printer 303, of setting information (detailed setting button ON/OFF value) of the web browser plug-in 306.

In step S1523, the web browser plug-in requests a detailed print setting screen from the relay virtual printer 303 via the web browser 305. The relay virtual printer 303 returns the detailed print setting screen in response to the request of the detailed print setting screen.

In step S1528, the relay virtual printer 303 receives information about the detailed print setting set by the user. In step S1529, based on the print setting received in step S1520 and the detailed print setting received in step S1528, the relay virtual printer 303 recreates information regarding the print setting received from the printing service 304, which is a part of the print job. Specifically, the information illustrated in FIG. 10C is recreated to be information illustrated in FIG. 10D. FIG. 10D illustrates a result of selecting bookbinding setting on the detailed setting screen and recreating the information as information regarding new print setting.

In step S1530, the relay virtual printer 303 determines whether to acquire print data indicated by the print notification received in step S1518. In the case of acquisition, the relay virtual printer 303 requests acquisition of the print data from the printing service 304.

In step S1531, the relay virtual printer 303 acquires the print data from the printing service 304. In step S1533, the relay virtual printer 303 stores the acquired print data. The print data generation unit 612 then processes the stored print data, the information regarding the print setting, or the notification information according to a result illustrated in FIG. 16. Examples of data processing are conversion of a Portable Document Format (PDF) into a Page Description Language (PDL), generation of a preview, conversion of the information illustrated in FIG. 10C into that illustrated in FIG. 10D, and generation of the information illustrated in FIG. 10E.

In step S1534, the relay virtual printer 303 notifies the printing control unit 301 of generation of a job. In step S1535, the printing control unit 301 requests acquisition of the print setting from the relay virtual printer 303. In step S1536, the printing control unit 301 acquires the print setting from the relay virtual printer 303.

In step S1537, the printing control unit 301 requests acquisition of the print data from the relay virtual printer 303. In step S1538, the printing control unit 301 acquires the print data from the relay virtual printer 303. In step S1539, the printing control unit 301 draws a raster image based on the acquired print setting and the acquired print data, and causes the image forming apparatus 101 to print the raster image.

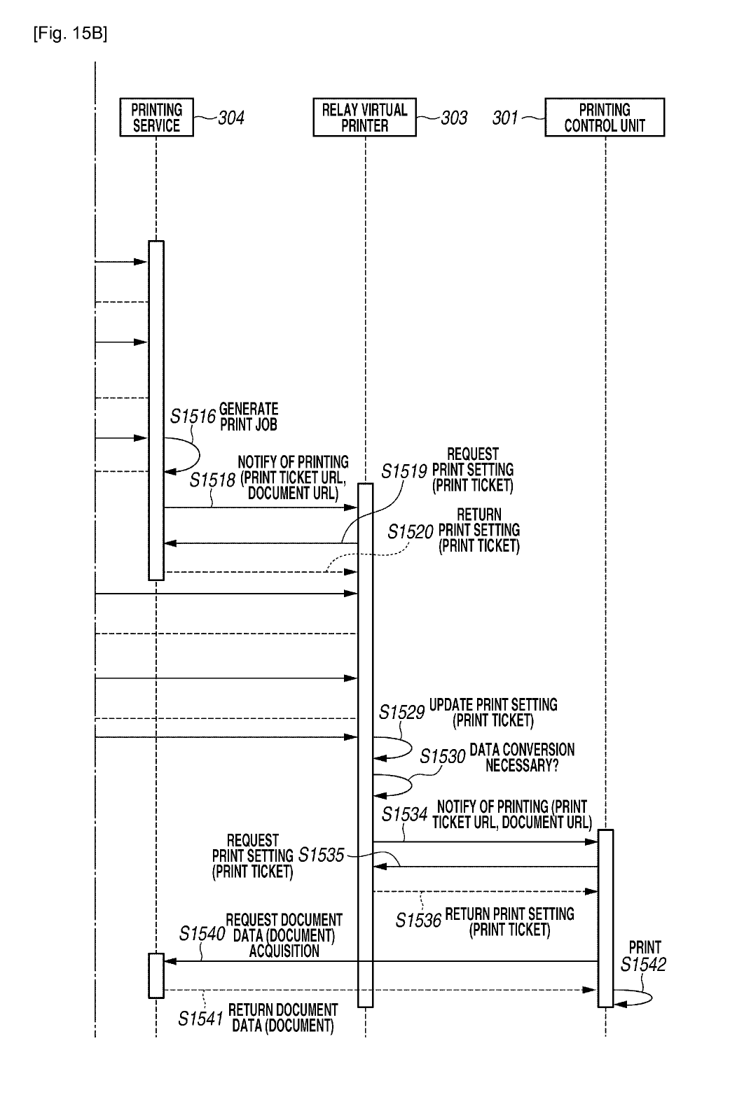

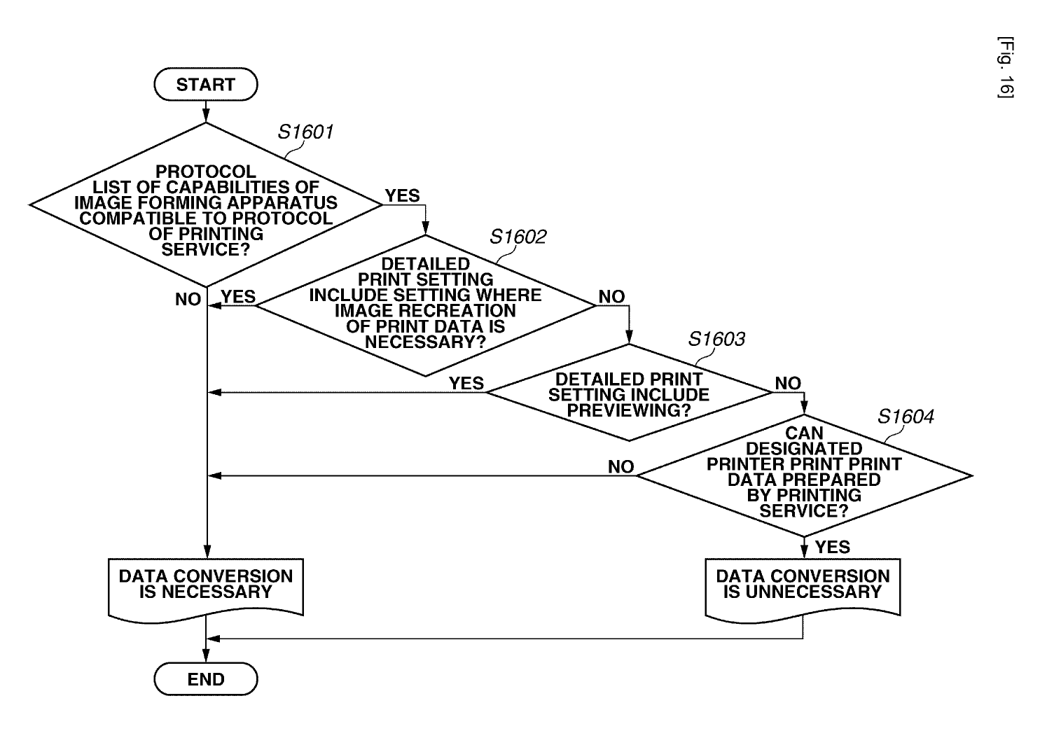

Referring to FIGS. 15A and 15B, an operation when the relay virtual printer 303 determines not to acquire the print data in step S1530 is described. The processing in steps of S1501 to S1536 are as described above.

When it is determined that the print data is not acquired, in step S1540, the printing control unit 301 requests the received storage place in the print notification, namely acquisition of the print data, to the printing service 304. In step S1541, the printing control unit 301 acquires the print data from the printing service 304. In step S1542, the printing control unit 301 draws a raster image based on the acquired print setting and the acquired print data, and causes the image forming apparatus 101 to print the raster image.

The above-described configuration provides the following effects. In the relay virtual printer, when there is no need to acquire print data, the print data included in the printing service is directly acquired by the image forming apparatus. Thus data traffic and processing loads on the relay virtual printer can be reduced. A frequency that the print data passes through the network is reduced, and hence processing performance can be improved. Even when the server including the printing service changes specifications of the interface for providing the printing service, the image forming apparatus can deal with the specification change without changing specifications of the interface thereof.

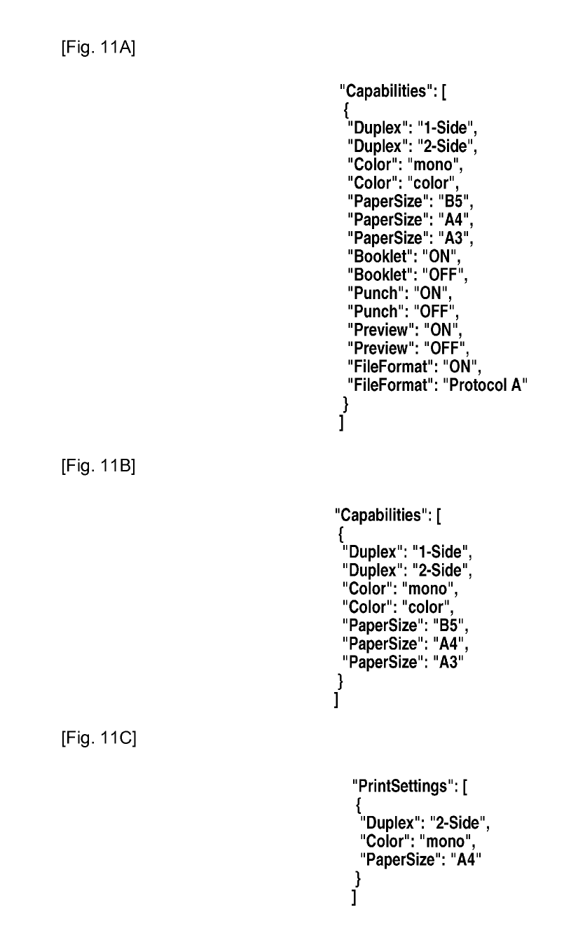

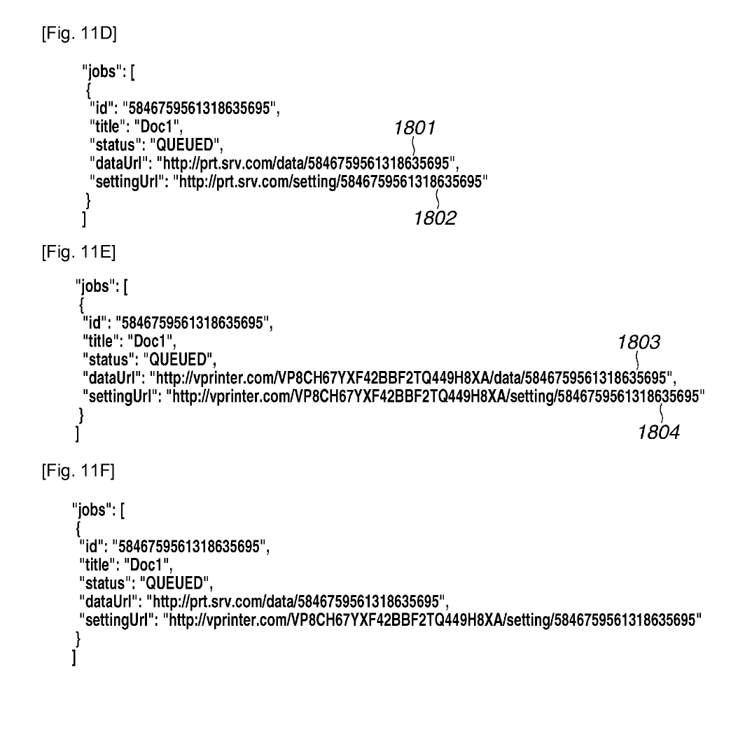

In the first exemplary embodiment, when the print server group 103 creates the print setting screen, the print setting screen is created using the capabilities expressed in the XML format. However, other formats can be used. For example, the capabilities expressed in the JSON formats as illustrated in FIGS. 11A and 11B can be acquired.

Further, in the first exemplary embodiment, the client computer 104 transmits the print setting in the XML format to the print server group 103. However, other formats can be used. For example, the print setting expressed in the JSON formats as illustrated in FIG. 11C and FIG. 11C′ cab be transmitted.

Furthermore, in the first exemplary embodiment, the notification information A and the notification information B are produced in the same XML format. However, formats can be different each other. For example, the notification information A can be expressed in the JSON format as illustrated in FIG. 11D. In FIG. 11D, the information includes descriptions of a storage place 1801 of the print data and a storage place 1802 of the print data. The reverse can be employed. For example, the notification information A can be expressed in the XML format, while the notification information pieces B and C can be expressed in the JASON formats as illustrated in FIGS. 11E and 11F. In FIG. 11E, the information includes the descriptions of a storage place 1803 of the print data and a storage place 1804 of the print data.

Program codes installed in a computer to realize functions of the present invention by the computer themselves realize the invention. In other words, claims of the present invention include a computer program itself to realize the functions of the invention. In this case, as long as there are program functions, any program forms can be used, such as an object code, a program executed by an interpreter, or script data supplied to an Operating System (OS).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2010-259296, filed Nov. 19, 2010, which is hereby incorporated by reference herein in its entirety.

### Reference Signs List

301 printing control unit

302 relay virtual printer management service

303 relay virtual printer

304 printing service

410 communication module B′

610 communication module A′

602 communication module B

707 communication module A

1. A print relay system capable of communicating with a printing service system that generates and stores print data based on contents instructed to be printed via an information terminal operated by a user and an image forming apparatus that outputs image data based on the print data, the print relay system comprising:
a reception unit configured to receive, when receiving a printing instruction for causing the image forming apparatus to output the image data from the printing service system, the printing instruction without receiving the print data;
a determination unit configured to determine whether the print data needs to be received from the printing service system; and
a notification unit configured to notify, if the reception unit receives the printing instruction and the determination unit determines that there is no need to receive the print data, of a storage place of the print data stored in the printing service system, to receive and store, if the reception unit receives the printing instruction and the determination unit determines that the print data needs be received, the print data from the printing service system, and to notify of the storage place of the stored print data.

2. The print relay system according to claim 1, further comprising a setting reception unit configured to provide, to the information terminal, a screen for setting detailed print setting which is not be able to set on a print setting screen provided from the printing service system, and receive the detailed print setting set by the user via the screen,
wherein the determination unit determines whether the print data needs to be acquired from the printing service system based on the detailed print setting received by the setting reception unit.

3. The print relay system according to claim 2, wherein the determination unit determines, based on the detailed print setting received by the setting reception unit, that the print data needs to be acquired from the printing service system in accordance with recognition that a layout of the print data needs to be changed.

4. The print relay system according to claim 3, wherein the determination unit determines, based on the detailed print setting received by the setting reception unit, that the print data needs to be acquired from the printing service system in accordance with recognition that a preview of the print data needs to be generated.

5. The print relay system according to claim 4, further comprising a confirmation unit configured to confirm, based on information regarding a communication protocol contained in registration information of the image forming apparatus, whether the image forming apparatus includes a communication protocol necessary for communication with the printing service system,
wherein the determination unit determines that the print data needs to be acquired from the printing service system in accordance with confirmation by the confirmation unit that the image forming apparatus does not include the communication protocol necessary for communication with the printing service system.

6. The print relay system according to claim 5, further comprising a determining unit configured to determine, based on information regarding a type of print data processable by the image forming apparatus which is contained in the registration information of the image forming apparatus, whether the print data generated by the printing service system can be processed,
wherein the determination unit determines, in accordance with determination by the determining unit that the image forming apparatus cannot process the print data generated by the printing service system, that the print data needs to be acquired from the printing service system.

7. A printing system comprising:
a print relay system capable of communicating with a printing service system that generates print data based on contents instructed to be printed via an information terminal operated by a user and stores the generated print data; and
an image forming apparatus,
wherein the print relay system includes:
a notification unit configured to notify of a storage place of the print data,
wherein the image forming apparatus includes:
a reception unit configured to receive a notification from the notification unit; and
an acquisition unit configured to acquire, if the print data is acquired based on the notification received by the reception unit, the print data by one of an acquisition method for acquiring the print data from the printing service system and an acquisition method for acquiring the print data from the print relay system,
wherein the print relay system further includes:
a data acquisition unit configured to acquire, if the acquisition method for acquiring the print data from the print relay system is notified, the print data stored in the printing service system; and
a providing unit configured to provide the print data acquired by the data acquisition unit to the image forming apparatus that acquires the print data by the acquisition method for acquiring the print data from the print relay system.

8. An image forming apparatus capable of communicating with a printing service system that generates print data based on contents instructed to be printed via an information terminal operated by a user and stores the generated print data, and a print relay system capable of communicating with the printing service system, the image forming apparatus comprising:
an acquisition unit configured to acquire, when print data is acquired, based on a printing instruction which is transmitted from the printing service system to the print relay system and transmitted to the image forming apparatus via the print relay system, the print data by one of an acquisition method for acquiring the print data from the printing service system and an acquisition method for acquiring the print data from the print relay system; and
an output unit configured to output image data based on the print data acquired by the acquisition unit.

9. A method for controlling a print relay system capable of communicating with a printing service system that generates print data based on contents instructed to be printed via an information terminal operated by a user and an image forming apparatus that outputs image data based on the print data, the method comprising:
receiving, by a reception unit, when a printing instruction for causing the image forming apparatus to output the image data is received from the printing service system, the printing instruction without receiving the print data;
determining, by a determination unit, whether the print data needs to be received from the printing service system;
notifying, by a notification unit, when the reception unit receives the printing instruction and the determination unit determines that there is no need to receive the print data, of a storage place of the print data stored in the printing service system; and
acquiring and storing, when the reception unit receives the printing instruction and the determination unit determines that the print data needs to be acquired, the print data from the printing service system, and notifying of the storage place of the print data stored in the print relay system.

10. A non-transitory computer readable medium storing a program causing a computer to implement a method according to claim 9.

11. A print relay system capable of communicating with a printing service system that generates and stores a print job based on contents instructed to be printed via an information terminal operated by a user and an image forming apparatus that acquires the print job based on location information of the print job and outputs image data based on the acquired print job, the print relay system comprising:
a reception unit configured to receive the location information of the print job stored in the printing service system from the printing service system; a determination unit configured to determine, after reception of the location information, whether the print job needs to be updated at the print relay system before the print job is acquired; and
a notification unit configured to notify, when updating is determined unnecessary, the image forming apparatus of the received location information, and when updating is determined necessary, acquire the print job from the printing service system based on the location information, update and store the acquired print job, and notify the image forming apparatus of location information of the updated and stored print job.
